(19) United States
(12) Patent Application Publication
(10) Pub. No.: US 2009/0025736 A1
(43) Pub. Date: Jan. 29, 2009

(54) METHOD AND DEVICE FOR MAKING TOBACCO SMOKE FILTERS

(75) Inventors: Neal G. Stewart, Hong Kong (CN); Robert D. Makepeace, Matthews, NC (US); Reid W. von Borstel, Potomac, MD (US)

Correspondence Address: SHELDON MAK ROSE & ANDERSON PC, 100 Corson Street, Third Floor, PASADENA, CA, 91103-3842, US

(73) Assignee: FILLIGENT LIMITED, Central, Hong Kong, R.O.C. (CN)

(21) Appl. No.: 11/718,081

(22) PCT Filed: Apr. 17, 2007
(86) PCT No.: PCT/US2007/066789

§ 371 Date: Apr. 26, 2007

Related U.S. Application Data
(60) Provisional application No. 60/744,995, filed on Apr. 17, 2006.
(60) Provisional application No. 60/887,960, filed on Feb. 2, 2007.

(51) Int. Cl. A24D 3/02; A24F 1/20; B31C 99/00; C08K 5/3467

(52) U.S. Cl. 131/202; 524/98; 493/47; 493/49

(57) ABSTRACT

A composition useful for treating the substrate of a tobacco smoke filter. A tobacco smoke filter comprising one or more than one free porphyrin or one or more than one free metal phthalocyanine. A seamless tobacco smoke filter (80, 90) comprising a first segment and a second segment. A device (110) for making a tobacco smoke filter from tobacco smoke filter substrate comprising a rod maker machine (112) and an applicator (120) for applying one or more than one additive intermittently to the substrate in a plurality of spaced bands.

### CROSS-REFERENCE TO RELATED APPLICATIONS

The present Application claims priority from U.S. Provisional Patent Application 60/744,995 filed Apr. 17, 2006 and titled “Method and Device for Making a Multiple Segment Tobacco Smoke Filter”; and also claims priority from U.S. Provisional Patent Application 60/887,960, filed Feb. 2, 2007 and titled “Method and Device for Making Tobacco Smoke Filters”; the contents of which are incorporated in this disclosure by reference in their entirety.

### BACKGROUND

Some tobacco smoke filters comprise multiple filter segments, where one segment is a standard filter comprising cellulose acetate filter material (the “standard segment”), and where the other segment or segments comprise one or more than one additional additive (the “non-standard segment”). Examples of such additional additives include flavoring agents, and further include substances that selectively reduce the amounts or toxicity of potentially harmful components of tobacco smoke, such as activated carbon granules. When the tobacco smoke filter comprises multiple segments, such as for example a two-segment filter, the standard segment is usually placed at the proximal end of the tobacco smoking product that comes in contact with the lips of the smoker, and the non-standard filter segment or segments are usually placed at the distal end of the tobacco smoking product adjacent the tobacco section of the tobacco smoking product, that is, between the standard segment and the tobacco section.

The production of tobacco smoking products having only a standard single segment tobacco smoke filter of cellulose acetate involves high-speed equipment, processing cellulose acetate tow into standard filter rods at a variable rate as high as 500 meters per minute. More specifically, standard single segment tobacco smoke filters are made using a standard “rod maker” machine by virtually all tobacco smoke filter manufacturers, machines which are readily available from a number of manufacturers. The rod maker machine continuously strips cellulose acetate tow from a compressed bale at one side of the machine. Tow comprises up to about 10,000 parallel individual fibers that are crimped into a bulky tow and that are compressed into large bales. The tow is then spread laterally into a flat sheet of separated fibers as it enters the rod maker machine, which predisposes the final filter toward a uniform density of fibers as it is formed into the filter rod, and also prepares the tow for the application of triacetin. Next, the tow passes through an application unit with a covered chamber where brushes rotate in a pan of triacetin causing triacetin droplets to suspend in the air, thereby exposing the tow to the droplets of triacetin. Triacetin is a plasticizer which cross-links the cellulose acetate fibers in the tow to impart a degree of rigidity to the tow material as it is further processed. Then, the triacetin sprayed tow is fed into a funnel that shapes the triacetin sprayed tow into a standard tow rod. Next, a strip of paper is wrapped around the standard two rod and sealed with hot glue as the rod passes from the funnel into a cutting unit, where the paper-wrapped rods are cut into standard filter segments. After cutting, the standard filter segments are fed into grooves on a rotating cylinder that releases the standard filter segments onto a conveyor belt for distribution to the area where tobacco segments are attached to form the complete the tobacco smoking products.

The production of tobacco smoking products comprising multiple segment filters, however, requires additional expensive equipment or substantial, expensive changes to standard manufacturing processes and equipment for making standard single segment filters. For example, present methods for producing multiple segment filter tobacco smoking products comprise: 1) using two separate rod maker machines, each with a spray unit and cutting unit to separately create rods of the standard filter material, and rods of the non-standard filter material, and to mechanically cut each of the rods to produce standard filter sections of double the length of the final standard filter section and non-standard filter sections of double the length of the final non-standard filter section; 2) mechanically combining the double length standard filter sections with the double length non-standard filter sections using a machine referred to in the industry as a high speed “combiner” to form rods of multiple segment filters, such as for example by wrapping the alternating standard filter sections and non-standard filter sections with paper and glueing the alternating sections. together; 3) cutting the combined rods to create multiple segment filters containing a standard filter segment and non-standard filter segment; and 4) attaching the multiple segment filters to a tobacco segment to create the completed tobacco smoking product, such as a cigarette or cigar.

Referring now to FIG. 1, there is shown a schematic diagram of some steps of one presently used method for producing multiple segment filter tobacco smoking products, such as a tobacco smoking product having a two-segment filter. As can be seen in FIG. 1, first separate rods of the standard filter material 10 and non-standard filter material 12 are created. Next, each rod of the standard filter material 10 is cut to produce double length standard filter sections 14, and each rod of the non-standard filter material 12 is cut to produce double length non-standard filter sections 16. Then, the double length standard filter sections 14 and double length non-standard filter sections 16 are combined into a multiple segment rod 18, and the multiple segment rod 18 is cut as indicated at 19 to produce rods having a pair of two segment filters joined together 20. Next, a tobacco segment 22 is attached to each end of the cut rod having a pair of two segment filters joined together 20 as shown. The rod having a pair of two segment filters joined together 20 with the tobacco segments 22 attached to each end is then cut in the center 24 as indicated to produce the final tobacco smoking product 26 having a multiple segment filter 28 attached to a tobacco segment 22.

As can be appreciated, this method for making a tobacco smoking product comprising a multiple segment filter is considerable more complex than the standard method for making a tobacco smoking product with only a single standard segment filter. Further, this method requires expensive equipment in addition to the standard rod maker machine.

Therefore, there is a need for a method for making a tobacco smoking product comprising a multiple segment filter that does not require the complex steps of the presently used method, and that does not require expensive additional equipment other than the standard rod maker machine.

### SUMMARY

According to one embodiment of the present invention, there is provided a composition useful for treating the substrate of a tobacco smoke filter. The composition comprises a) one or more than one solvent; b) one or more than one polycationic polymer; and c) i) one or more than one free porphyrin, or ii) one or more than one free metal phthalocyanine, or iii) both one or more than one free porphyrin and one or more than one free metal phthalocyanine.

According to another embodiment of the present invention, there is provided a tobacco smoke filter. In one embodiment, the tobacco smoke filter comprises an axial length, and further comprises: a) a substrate; and b) one or more than one additive; where the additive comprises one or more than one free porphyrin or one or more than one free metal phthalocyanine, or both one or more than one free porphyrin and one or more than one free metal phthalocyanine. In another embodiment, the tobacco smoke filter comprises an axial length, and further comprises: a) a substrate; and b) one or more than one additive; where the tobacco smoke filter further comprises a first segment and a second segment, where the additive is not present in the first segment, but where the additive is present in the second segment; and where the tobacco smoke filter is seamless. In another embodiment, the tobacco smoke filter comprises a composition according to the present invention.

According to another embodiment of the present invention, there is provided a tobacco smoking product comprising a tobacco smoke filter according to the present invention affixed to a body of tobacco.

According to another embodiment of the present invention, there is provided a device for making a tobacco smoke filter from tobacco smoke filter substrate. The device comprises: a) a rod maker machine comprising a conveyor for moving the substrate through the machine, a shaping mechanism for shaping the substrate into a cylinder, and a cutting mechanism for cutting the shaped substrate into segments; b) an applicator for applying one or more than one additive intermittently to the substrate in a plurality of spaced bands; and c) a controller for controlling the applicator, where the controller connected is to the applicator.

According to another embodiment of the present invention, there is provided a method for making a tobacco smoke filter. In one embodiment, the method comprises: a) providing a composition according to the present invention; b) applying the composition to a substrate; and c) incorporating the substrate into a tobacco smoke filter. In another embodiment, the tobacco smoke filter made is a tobacco smoke filter according to the present invention, and the method comprises: a) providing the substrate; b) providing the one or more than one additive; and c) applying the one or more than one additive to the substrate. In another embodiment, the method comprises: a) providing a device according to the present invention; b) allowing the applicator of the device to apply the one or more than one additive to a substrate; and c) incorporating the substrate into the tobacco smoke filter. In another embodiment, the method comprises: a) providing one or more than one additive and one or more than one substrate; b) applying the one or more than one additive to the one or more than one substrate before the substrate is formed into or spun into fibers; c) forming or spinning the substrate into fibers; d) collecting and crimping the substrate fibers to make filter tow; and e) incorporating the filter tow into the tobacco smoke filter.

According to another embodiment of the present invention, there is provided a method for making a tobacco smoking product. The method comprises: a) providing a tobacco smoke filter according to the present invention; and b) affixing a body of tobacco to the tobacco smoke filter.

### FIGURES

These and other features, aspects and advantages of the present invention will become better understood with regard to the following description, appended claims, and accompanying figures where:

FIG. 1 is a schematic diagram of some steps of one presently used method for producing multiple segment filter tobacco smoking products;

FIG. 2 is a cutaway, lateral perspective view of a single segment tobacco smoke filter according to the present invention;

FIG. 3 is a cutaway, lateral perspective view of a first seamed multiple segment tobacco smoke filter according to one embodiment of the present invention;

FIG. 4 is a cutaway, lateral perspective view of a second seamed multiple segment tobacco smoke filter according to the present invention;

FIG. 5 is a cutaway, lateral perspective view of a first seamless multiple segment tobacco smoke filter according to another embodiment of the present invention;

FIG. 6 is a cutaway, lateral perspective view of a second seamless multiple segment tobacco smoke filter according to another embodiment of the present invention;

FIG. 7 is a partial cutaway lateral perspective view of a tobacco smoking product according to the present invention; and

FIG. 8 is a schematic diagram of a device for making a tobacco smoke filter according to the present invention.

### DESCRIPTION

According to the present invention, there is provided a composition useful for treating the substrate of a tobacco smoke filter to selectively reduce the amounts or toxicity of potentially harmful components of tobacco smoke. In one embodiment, the composition is particularly useful for treating the substrate cellulose acetate.

According to another embodiment of the present invention, there is provided a tobacco smoke filter. The tobacco smoke filter comprises a substrate and further comprises one or more than one additive. In one embodiment, the substrate is cellulose acetate. In one embodiment, the additive is selected from the group consisting of one or more than one substance for selectively reducing the amounts or toxicity of potentially harmful components of tobacco smoke, one or more than one composition for selectively reducing the amounts or toxicity of potentially harmful components of tobacco smoke, and both one or more than one substance for selectively reducing the amounts or toxicity of potentially harmful components of tobacco smoke and one or more than one composition for selectively reducing the amounts or toxicity of potentially harmful components of tobacco smoke. In a preferred embodiment, the composition is a composition for selectively reducing the amounts or toxicity of potentially harmful components of tobacco smoke according to the present invention.

In one embodiment, the tobacco smoke filter is a single segment tobacco smoke filter where the additive is present uniformly throughout the axial length of the tobacco smoke filter. In another embodiment, the tobacco smoke filter is a seamed multiple segment tobacco smoke filter comprising a plurality of segments, where the additive is present in at least one of the segments of the tobacco smoke filter, and where the additive is not present in at least one of the segments of the tobacco smoke filter. In another embodiment, the tobacco smoke filter is a seamless multiple segment tobacco smoke filter comprising a plurality of segments, where the additive is present in at least one of the segments of the tobacco smoke filter, and where the additive is not present in at least one of the segments of the tobacco smoke filter.

According to another embodiment of the present invention, there is provided a tobacco smoking product comprising a tobacco smoke filter made according to the present invention, and further comprising a tobacco segment. According to another embodiment of the present invention, there is provided a tobacco smoking product comprising a tobacco smoke filter according to the present invention, and further comprising a tobacco segment. A tobacco segment of a tobacco smoking product is often referred to as a “body of tobacco” or a “body of divided tobacco” in the industry.

According to one embodiment of the present invention, there is provided a device for making a tobacco smoke filter. In one embodiment, the tobacco smoke filter made is a single segment tobacco smoke filter. In another embodiment, the tobacco smoke filter made is a multiple segment tobacco smoke filter. In another embodiment, the tobacco smoke filter made is a seamed multiple segment tobacco smoke filter. In another embodiment, the tobacco smoke filter made is a seamless multiple segment tobacco smoke filter. In another embodiment, the tobacco smoke filter made is a tobacco smoke filter according to the present invention. In one embodiment, the device of the present invention is a standard rod maker of the type already available to virtually all manufacturers of tobacco smoke filters, where the device has been modified or adapted according to the present invention.

According to another embodiment of the present invention, there is provided a method for making a tobacco smoke filter. In one embodiment, the tobacco smoking filter made according to the method comprises a composition according to the present invention. In one embodiment, the tobacco smoke filter made according to the method is a single segment tobacco smoke filter. In another embodiment, the tobacco smoke filter made according to the method is a multiple segment tobacco smoke filter. In another embodiment, the tobacco smoke filter made according to the method is a seamed multiple segment tobacco smoke filter. In another embodiment, the tobacco smoke filter made according to the method is a seamless multiple segment tobacco smoke filter. In another embodiment, the tobacco smoke filter made according to the method is a tobacco smoke filter according to the present invention. In one embodiment, the method comprises providing a device according to the present invention.

According to another embodiment of the present invention, there is provided a method for making a tobacco smoking product. In one embodiment, the tobacco smoking product made according to the method comprises a composition according to the present invention. In one embodiment, the tobacco smoking product made according to the method comprises a tobacco smoke filter according to the present invention. In another embodiment, the tobacco smoking product made according to the method comprises a single segment tobacco smoke filter according to the present invention. In another embodiment, the tobacco smoking product made according to the method comprises a multiple segment tobacco smoke filter according to the present invention. In another embodiment, the tobacco smoking product made according to the method comprises a seamed multiple segment tobacco smoke filter according to the present invention. In another embodiment, the tobacco smoking product made according to the method comprises a seamless multiple segment tobacco smoke filter according to the present invention.

The composition, device and method of the present invention permit the industrial scale preparation of tobacco smoke filters and tobacco smoking products with tobacco smoke-modifying additives.

As used herein, except where the context requires otherwise, the term “comprise” and variations of the term, such as “comprising,” “comprises” and “comprised” are not intended to exclude other additives, components, integers or steps.

All dimensions specified in this disclosure are by way of example only and are not intended to be limiting. Further, the proportions shown in these Figures are not necessarily to scale. As will be understood by those with skill in the art with reference to this disclosure, the actual dimensions of any device or part of a device disclosed in this disclosure will be determined by its intended use.

As used herein, “seamless multiple segment tobacco smoke filter” and variations of the phrase, means that the fibers of the substrate of the tobacco smoke filter, such as cellulose, cellulose acetate, cotton, paper, polypropylene and rayon, are continuous between the segments, or in other words, the fibers of the substrate of the tobacco smoke filter were never separated perpendicular to the axial length of the filter at the junction of the segments, such as by being cut.

As used herein, “seamed multiple segment tobacco smoke filter” and variations of the phrase, means that the fibers of the substrate of the tobacco smoke filter, such as cellulose, cellulose acetate, cotton, paper, polypropylene and rayon, are not continuous (discontinuous) between the segments, or in other words, the fibers of the substrate of the tobacco smoke filter were separated perpendicular to the axial length of the filter at the junction of the segments at one time, such as by being cut.

As used herein, “triacetin” by itself is not an “additive” as used in this disclosure when the triacetin is applied to the substrate cellulose acetate to form standard cellulose acetate tow because triacetin is necessary to produce the standard cellulose acetate tow, and therefore triacetin does not function as an “additive” but rather is an integral part of formation of the cellulose acetate tow.

According to the present invention, there is provided a composition useful for treating the substrate of a tobacco smoke filter. In one embodiment, the composition selectively reduces the amounts or toxicity of potentially harmful components of tobacco smoke. In another embodiment, the composition is particularly useful for treating the tobacco smoke filter substrate cellulose acetate. In one embodiment, the composition comprises a) one or more than one solvent, b) one or more than one polycationic polymer, and c) i) one or more than one free porphyrin or ii) one or more than one free metal phthalocyanine, or iii) both one or more than one free porphyrin and one or more than one free metal phthalocyanine. In a preferred embodiment, the one or more than one solvent is selected from the group consisting of ethanol and isopropanol. In a particularly preferred embodiment, the solvent is triacetin. Triacetin is commonly used as a plasticizer and crosslinker for the tobacco smoke filter substrate cellulose acetate, besides also being useful as one part of the composition according to the present invention.

In one embodiment, the one or more than one polycationic polymer has a cationic moiety comprising one or more than one primary or secondary amino group. In a preferred embodiment, the one or more than one polycationic polymer is selected from the group consisting of poly(propyleneimine), polyvinylamine, poly(2-ethylaziridine), poly(2,2-dimethylaziridine, and poly(2,2-dimethyl-3-n-propylaziridine) and a combination of the preceding. In a particularly preferred embodiment, the one or more than one polycationic polymer is polyethyleneimine (PEI).

In another embodiment, the composition comprises both one or more than one free porphyrin and one or more than one free phthalocyanine. In one embodiment, the one or more than one free porphyrin is free chlorophyllin. In one embodiment, the one or more than one free metal phthalocyanine is selected from the group consisting of one or more than one free copper phthalocyanine and free iron phthalocyanine. In a preferred embodiment, the one or more than one free iron phthalocyanine is an iron phthalocyanine comprising trivalent (ferrous) iron. In a preferred embodiment, the one or more than one free metal phthalocyanine is a free iron phthalocyanine comprising divalent (ferric) iron. The use of “free” in “free metal phthalocyanine” and in “free chlorophyllin” means that the metal phthalocyanine and the chlorophyllin are not complexed to another chemical structure, that is, the free metal phthalocyanine or the free chlorophyllin is not a substructure of a larger chemical moiety such as a dye. A free metal phthalocyanine and free chlorophyllin have the advantage of not having additional anionic groups that are often present in the other portion of larger structures, anionic groups such as sulfonate groups in water soluble reactive phthalocyanine dyes. Therefore, free metal phthalocyanines and free chlorophyllin advantageously do not tend to attract and bind nicotine in tobacco smoke, which disadvantageously reduces the ratio of nicotine/mutagen in the tobacco smoke rendering the tobacco smoking product less acceptable to the user.

In one embodiment, the composition comprises between 20% and 80% of the one or more than one solvent, where the percents given are percent of the total weight of the composition. In one embodiment, the composition comprises between 10% and 40% of the one or more than one polycationic polymer, where the percents given are percent of the total weight of the composition. In another embodiment, the composition comprises between 10% and 20% of the one or more than one free porphyrin, where the percents given are percent of the total weight of the composition. In another embodiment, the composition comprises between 10% and 20% of the one or more than one free metal phthalocyanine, where the percents given are percent of the total weight of the composition. In another embodiment, the composition comprises between 10% and 20% total of both the one or more than one free porphyrin and one or more than one free metal phthalocyanine, where the percents given are percent of the total weight of the composition.

In a preferred embodiment, the composition consists of triacetin as the solvent, one or more than one polycationic polymer, and one or more than one free copper phthalocyanine. In another preferred embodiment, the composition consists of triacetin as the solvent, one or more than one polycationic polymer, and one or more than one free iron phthalocyanine. In a preferred embodiment, the composition comprises between 40% and 80% triacetin, between 10% and 40% polyethyleneimine and between 10% and 20% free copper phthalocyanine or free iron phthalocyanine, where the percents given are percent of the total weight of the composition. In another particularly preferred embodiment, the composition consists of between 40% and 80% triacetin, between 10% and 40% polyethyleneimine, and between 10% and 20% free copper phthalocyanine and free iron phthalocyanine, where the percents given are percent of the total weight of the composition.

According to another embodiment of the present invention, there is provided a tobacco smoke filter. The tobacco smoke filter comprises an axial length. The tobacco smoke filter further comprises a substrate, and further comprises one or more than one additive.

In one embodiment of the tobacco smoke filter, the additive comprises one or more than one free porphyrin or one or more than one free metal phthalocyanine, or both one or more than one free porphyrin and one or more than one free metal phthalocyanine. In this embodiment, the additive can further comprise one or more than one solvent and one or more than one polycationic polymer. The tobacco smoke filter can also comprise a first segment and a second segment, where the additive is not present in the first segment, but where the additive is present in the second segment. In a preferred embodiment, the tobacco smoke filter is seamless.

In another embodiment of the tobacco smoke filter, the tobacco smoke filter further comprises a first segment and a second segment, and the additive is not present in the first segment, but the additive is present in the second segment, and the tobacco smoke filter is seamless. In one embodiment, the additive comprises a) one or more than one solvent; b) one or more than one polycationic polymer; and c) one or more than one free porphyrin, or one or more than one free metal phthalocyanine, or both one or more than one free porphyrin and one or more than one free metal phthalocyanine. In another embodiment, the additive is selected from the group consisting of chlorophyll, chlorophyllin, ion exchange resin granules, lignin, a metal phthalocyanine, chitin granules covalently linked to a metal phthalocyanine, activated charcoal, and activated charcoal impregnated with a metal phthalocyanine or chlorophyllin.

In one embodiment of the tobacco smoke filter, the substrate is selected from the group consisting of cellulose, cotton, paper, polypropylene and rayon. In a preferred embodiment, the substrate is cellulose acetate.

In a preferred embodiment, the one or more than one additive is a free copper phthalocyanine. In another preferred embodiment, the one or more than one additive is a free iron phthalocyanine.

In one embodiment, the tobacco smoke filter is a single segment tobacco smoke filter where the additive is present uniformly throughout the axial length of the tobacco smoke filter. In another embodiment, the tobacco smoke filter is a seamed multiple segment tobacco smoke filter comprising a first segment and a second segment, where the additive is not present in the first segment but is present in the second segment. In another embodiment, the tobacco smoke filter is a seamless multiple segment tobacco smoke filter comprising a first segment and a second segment, where the additive is not present in the first segment but is present in the second segment. The tobacco smoke filter of the present invention also includes tobacco smoke filters comprising three or more segments, both seamed and seamless, where the additive is present in less than all of the segments, as will be understood by those with skill in the art with reference to this disclosure. For example, in one embodiment, the tobacco smoke filter is a seamless multiple segment tobacco smoke filter, where the tobacco smoke filter comprises a first segment, a second segment and a third segment, where the additive is not present in at least one of the three segments.

In one embodiment, the first segment has an axial length, the second segment has an axial length, and the axial length of the first segment is different from the axial length of the second segment.

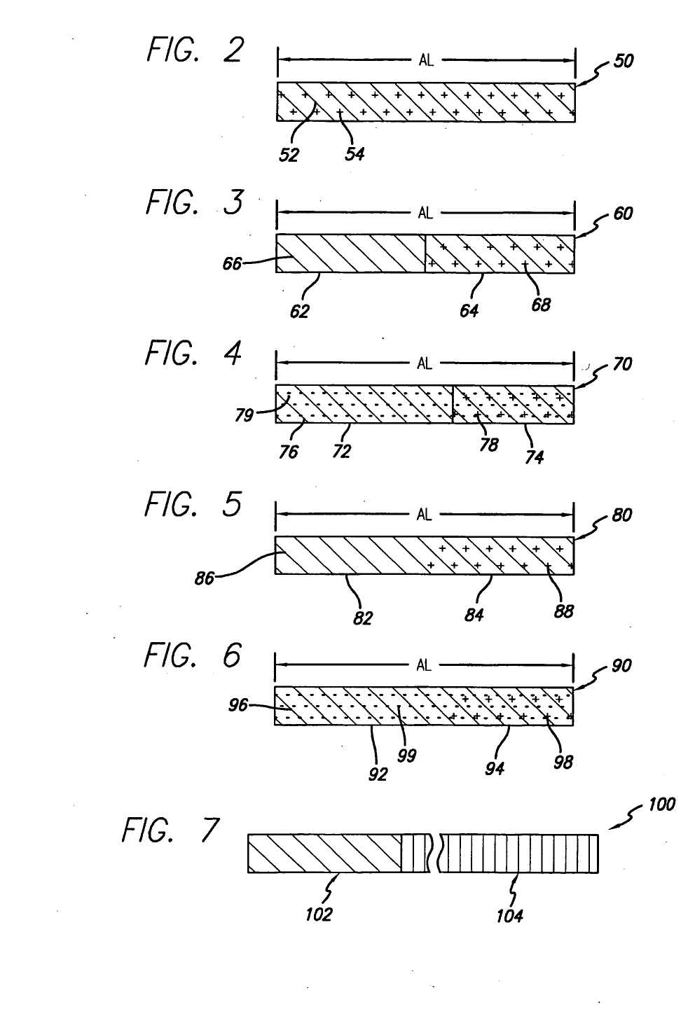

Referring now to FIG. 2, FIG. 3 and FIG. 4, there are shown respectively, a cutaway, lateral perspective view of a single segment tobacco smoke filter according to the present invention (FIG. 2); a cutaway, lateral perspective view of a first seamed multiple segment tobacco smoke filter according to one embodiment of the present invention (FIG. 3); a cutaway, lateral perspective view of a second seamed multiple segment tobacco smoke filter according to the present invention (FIG. 4); a cutaway, lateral perspective view of a first seamless multiple segment tobacco smoke filter according to another embodiment of the present invention (FIG. 5); and a cutaway, lateral perspective view of a second seamless multiple segment tobacco smoke filter according to another embodiment of the present invention (FIG. 6). As can be seen in FIG. 2, there is provided a single segment tobacco smoke filter 50 according to one embodiment of the present invention. The tobacco smoke filter 50 comprises an axial length AL, a substrate 52 (represented by hatching) and one or more additive 54 (represented by plus signs), and as can be seen, the one or more than one additive 54 is present uniformly throughout the axial length AL of the tobacco smoke filter 50.

As can be seen in FIG. 3, there is provided a seamed multiple segment tobacco smoke filter 60 according to another embodiment of the present invention. The tobacco smoke filter 60 comprises an axial length AL, a first segment 62, a second segment 64, a substrate 66 (represented by hatching) present throughout both the first segment 62 and the second segment 64, and one or more than one additive 68 (represented by plus signs), where the one or more than one additive 68 is present uniformly throughout the axial length of one of the segments (the second segment 64 in the example shown in FIG. 3), but is not present in the other segment (the first segment 62 in the example shown in FIG. 3). The fibers of the substrate 66 (represented by hatching) are not continuous (discontinuous) between the first segment 62 and the second segment 64, or in other words, the fibers of the substrate 66 of the tobacco smoke filter 60 were separated perpendicular to the axial length of the filter 60 at the junction of the first segment 62 and the second segment 64 at one time, such as by being cut. This is shown graphically in FIG. 3 by the discontinuity of the hatching between the first segment 62 and the second segment 64.

As can be seen in FIG. 4, there is provided a seamed multiple segment tobacco smoke filter 70 according to another embodiment of the present invention. The tobacco smoke filter 70 comprises an axial length AL, a first segment 72, a second segment 74, a substrate 76 (represented by hatching) present throughout both the first segment 72 and the second segment 74, a first additive 78 (represented by plus signs) and a second additive 79 (represented by dots), where the first additive 78 is present uniformly throughout the axial length of one of the segments (the second segment 74 in the example shown in FIG. 4) but is not present in the other segment (the first segment 72 in the example shown in FIG. 4), and where the second additive 79 is present uniformly throughout the axial length of tobacco smoke filter 70. The fibers of the substrate 76 (represented by hatching) are not continuous (discontinuous) between the first segment 72 and the second segment 74, or in other words, the fibers of the substrate 76 of the tobacco smoke filter 70 were separated perpendicular to the axial length of the filter 70 at the junction of the first segment 72 and the second segment 74 at one time, such as by being cut. This is shown graphically in FIG. 3 by the discontinuity of the hatching between the first segment 72 and the second segment 74.

As can be seen in FIG. 5, there is provided a seamless multiple segment tobacco smoke filter 80 according to another embodiment of the present invention. The tobacco smoke filter 80 comprises an axial length AL, a first segment 82, a second segment 84, a substrate 86 (represented by hatching) present throughout both the first segment 82 and the second segment 84, and one or more than one additive 88 (represented by plus signs), where the one or more than one additive 88 is present uniformly throughout the axial length of one of the segments (the second segment 84 in the example shown in FIG. 5), but is not present in the other segment (the first segment 82 in the example shown in FIG. 5). The fibers of the substrate 86 (represented by hatching) are continuous between the first segment 82 and the second segment 84, or in other words, the fibers of the substrate 86 of the tobacco smoke filter 80 were never separated perpendicular to the axial length of the filter 80 at the junction of the first segment 82 and the second segment 84 at one time, such as by being cut. This is shown graphically in FIG. 3 by the continuity of the hatching between the first segment 82 and the second segment 84.

As can be seen in FIG. 6, there is provided a seamless multiple segment tobacco smoke filter 90 according to another embodiment of the present invention. The tobacco smoke filter 90 comprises an axial length AL, a first segment 92, a second segment 94, a substrate 96 (represented by hatching) present throughout both the first segment 92 and the second segment 94, a first additive 98 (represented by plus signs) and a second additive 99 (represented by dots), where the first additive 98 is present uniformly throughout the axial length of one of the segments (the second segment 94 in the example shown in FIG. 6) but is not present in the other segment (the first segment 92 in the example shown in FIG. 6), and where the second additive 99 is present uniformly throughout the axial length of tobacco smoke filter 90. The fibers of the substrate 96 (represented by hatching) are continuous between the first segment 92 and the second segment 94, or in other words, the fibers of the substrate 96 of the tobacco smoke filter 90 were never separated perpendicular to the axial length of the filter 90 at the junction of the first segment 92 and the second segment 94 at one time, such as by being cut. This is shown graphically in FIG. 3 by the continuity of the hatching between the first segment 92 and the second segment 94.

As will be understood by those with skill in the art with reference to this disclosure, other embodiments are contemplated as part of the present invention, including tobacco smoke filters comprising three or more segments, and tobacco smoke filters comprising segments with other variations in the position of the one or more than one additive. As will be understood by those with skill in the art with reference to this disclosure, each “segment” depicted in FIG. 2 through FIG. 6, can actually be a plurality of segments, either seamed or seamless, and the representations shown in FIG. 2 through FIG. 6 are merely exemplary of some of the embodiments of the present invention.

According to another embodiment of the present invention, there is provided a tobacco smoking product comprising a tobacco smoke filter according to the present invention, or made according to the present invention, and further comprising a “body of tobacco” or a “tobacco segment” affixed to the tobacco smoke filter. Referring now to FIG. 7, there is shown a partial cutaway lateral perspective view of a tobacco smoking product according to the present invention. As can be seen, the tobacco smoking product 100 comprises a tobacco smoke filter 102 according to the present invention and further comprises a tobacco segment 104 affixed to the tobacco smoke filter 102.

According to one embodiment of the present invention, there is provided a device for making a tobacco smoke filter. In one embodiment, the tobacco smoke filter made is a single segment tobacco smoke filter. In another embodiment, the tobacco smoke filter made is a multiple segment tobacco smoke filter. In another embodiment, the tobacco smoke filter made is a seamed multiple segment tobacco smoke filter. In another embodiment, the tobacco smoke filter made is a seamless multiple segment tobacco smoke filter. In another embodiment, the tobacco smoke filter made is a tobacco smoke filter according to the present invention.

In one embodiment, the device of the present invention comprises a standard rod maker machine of the type already available to virtually all manufacturers of tobacco smoke filters, modified according to the present invention. A standard rod maker machine is a machine that converts tobacco smoke filter substrate into tobacco smoke filter rods, such as by shaping the substrate into a cylinder, sealing the cylinder circumferentially with paper, and then cutting the sealed cylinders into finished tobacco smoke filters. (The tobacco smoke filters are then added to a “tobacco segment” often called a “body of tobacco” to form the finished tobacco smoking product by another machine.) Standard rod maker machines generally comprise i) a conveyor for moving substrate through the machine, ii) a shaping mechanism such as a funnel for shaping the substrate into a cylinder, and iii) a cutting mechanism for cutting the shaped substrate into segments. Standard rod maker machines that process cellulose acetate as the substrate usually also include a mechanism for applying triacetin to the substrate, a necessary step in the production of the tobacco smoke filters from cellulose acetate, but do not include any other mechanism or structure for applying any other substance to the substrate during production of the tobacco smoke filter. Further, the mechanism for applying triacetin to the substrate does not apply triacetin or any other substance to the substrate in a plurality of spaced bands. Standard rod maker machines are available from a variety of manufacturers, such as for example, Hauni Werke Korber and Company KG (Hamburg, Germany) under the model identifiers KDF2 and KDF2E; Molins Richmond Inc. (Richmond, Va. US) under the model identifier PM3 and PM4; and Aiger Engineering Ltd. (Plovdiv, Bulgaria) under the model identifiers KDF2 and ITM “Polaris.”

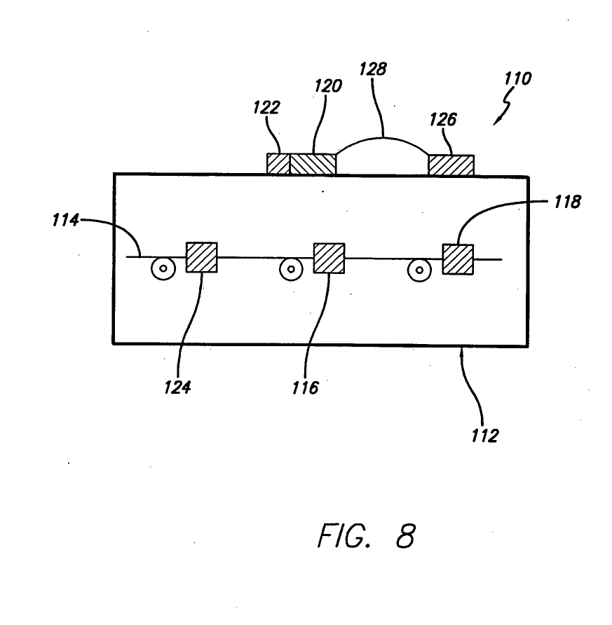

Referring now to FIG. 8, there is shown a schematic diagram of a device for making a tobacco smoke filter according to the present invention, such as for example a multiple segment tobacco smoke filter. As can be seen, the device 110 comprises a standard rod maker machine 112 indicated by the thick lined rectangle. The rod maker machine 112 comprises: i) a conveyor 114 for moving the substrate through the machine 112, ii) a shaping mechanism 116 for shaping the substrate into a cylinder, and iii) a cutting mechanism 118 for cutting the shaped substrate into segments. As shown schematically in FIG. 8, the substrate is processed by the standard rod making machine 112 into tobacco smoke filters from the left of FIG. 8 to the right of FIG. 8.

Further, as can be seen, in addition to the standard rod making machine 112, the device 110 further comprises an applicator 120 for applying one or more than one additive to the substrate. As will be understood by those with skill in the art with reference to this disclosure, the use of triacetin by itself as a plasticizer for making cellulose acetate tobacco smoke filters is not an “additive” within the context of this disclosure as triacetin is necessary for production of the cellulose acetate tobacco smoke filters, and therefore, triacetin as a plasticizer is not an “additive” to the tobacco smoke filter. In a preferred embodiment, the applicator 120 applies the one or more than one additive intermittently to the substrate in a plurality of spaced bands. The device 110 further comprises a controller 122 for controlling the applicator 120, and the controller 122 connected to the applicator 120.

In one embodiment, the rod maker machine 112 further comprises a mechanism 124 for applying triacetin to the substrate. When the rod maker machine 112 further comprises a mechanism 124 for applying triacetin to the substrate, the applicator 120 applies the additive to the substrate after the mechanism 124 applies triacetin to the substrate.

In one embodiment, the applicator 120 comprises one or more than one spray head for spraying the additive intermittently to the substrate in a plurality of spaced bands. In another embodiment, the applicator 120 comprises one or more than one rotatable wheel template for applying an additive intermittently to the substrate in a plurality of spaced bands.

In one embodiment, the applicator 120 comprises one or more than one pump for pumping the additive through the applicator 120. In another embodiment, the device 110 further comprises a sensor 126 and a cable 128 attached to the sensor 126 and to the applicator 120 to convey synchronizing signals to the applicator 120, thereby triggering the application of the bands. For example, in one embodiment, the sensor 126 senses production of the cut segments by the cutting mechanism 118.

In a preferred embodiment, the applicator 120 is positioned to apply the one or more than one additive to the substrate before the substrate enters the shaping mechanism 116. In a particularly preferred embodiment, the device comprises a mechanism 124 for applying triacetin to the substrate, and the applicator 120 is positioned to apply the one or more than one additive to the substrate after the mechanism 124 for applying triacetin to the substrate applies triacetin to the substrate but before the substrate enters the shaping mechanism 116. In another preferred embodiment, the applicator 120 is positioned to apply the one or more than one additive to the substrate while the substrate is within the shaping mechanism 116. In another preferred embodiment, the applicator 120 is positioned to apply the one or more than one additive to the substrate after the substrate has been shaped by the shaping mechanism 116.

The parts of device 110 that have been used to modify the standard rod maker machine 112, such as the applicator 120, the controller 122, the sensor 126 and the cable 128 can be purchased from any of several equipment manufacturers, as will be understood by those with skill in the art with reference to this disclosure, such as for example, from Aiger Engineering Ltd., Abco Automation Inc. (Brown Summit, N.C. US), Southlake Corp. (Richmond, Va. US), and Korber AG (through Studer Mikrosa GmbH, Leipzig Germany).

According to one embodiment of the present invention, there is provided a method for making a tobacco smoke filter. In one embodiment, the tobacco smoke filter comprises a composition according to the present invention. In another embodiment, the tobacco smoke filter made is a tobacco smoke filter according to the present invention. In one embodiment, the tobacco smoke filter made is a single segment tobacco smoke filter. In another embodiment, the tobacco smoke filter made is a multiple segment tobacco smoke filter. In another embodiment, the tobacco smoke filter made is a seamed multiple segment tobacco smoke filter. In another embodiment, the tobacco smoke filter made is a seamless multiple segment tobacco smoke filter. In another embodiment, the tobacco smoke filter made is a tobacco smoke filter according to the present invention.

In one embodiment, the method for making a tobacco smoke filter comprises: a) providing a composition according to the present invention; b) applying the composition to a substrate; and c) incorporating the substrate into a tobacco smoke filter. In a preferred embodiment, applying the composition comprises printing the composition in bands on the substrate. In another preferred embodiment, applying the composition comprises applying a plurality of bands of the composition. In one embodiment, the plurality of bands comprises at least one band with a first density of the composition and another band with a second density of the composition, and the first density is different from the second density. In another embodiment, the plurality of bands comprises at least one band with a first width and another band with a second width, and the first width is different from the second width. In one embodiment, the composition is applied in the form of granules or particles to increase the surface area of the composition within the tobacco smoke filter. In another embodiment, the composition is applied adsorbed onto granules.

In one embodiment, there is provided a method for making a tobacco smoke filter according to the present invention, such as a tobacco smoke filter comprising: a) a substrate; and b) one or more than one additive; where the additive comprises one or more than one free porphyrin or one or more than one free metal phthalocyanine, or both one or more than one free porphyrin and one or more than one free metal phthalocyanine. The method comprises: a) providing the substrate; b) providing the one or more than one additive; and c) applying the one or more than one additive to the substrate.

In one embodiment, there is provided a method for making a tobacco smoke filter according to the present invention, such as a tobacco smoke filter comprising: a) a substrate; and b) one or more than one additive; where the tobacco smoke filter further comprises a first segment and a second segment, where the additive is not present in the first segment, but where the additive is present in the second segment; and where the tobacco smoke filter is seamless. The method comprises: a) providing the substrate; b) providing the one or more than one additive; and c) applying the one or more than one additive to the substrate. As will be understood by those with skill in the art with reference to this disclosure, the use of triacetin by itself as a plasticizer for making cellulose acetate tobacco smoke filters is not an “additive” within the context of this disclosure as triacetin is necessary for production of the cellulose acetate tobacco smoke filters, and therefore, triacetin as a plasticizer is not an “additive” to the tobacco smoke filter.

In one embodiment, there is provided a method for making a tobacco smoke filter. The method comprises: a) providing a device according to the present invention; b) allowing the applicator of the device to apply the one or more than one additive to a substrate; and c) incorporating the substrate into the tobacco smoke filter.

In a preferred embodiment, the one or more than one additive provided comprises ethanol or isopropanol. In another preferred embodiment, the one or more than one additive provided comprises triacetin and one or more than one other substance.

In a preferred embodiment, applying the one or more than one additive comprises printing the additive in a plurality of spaced bands on the substrate.

In another preferred embodiment, applying the one or more than one additive to a substrate further comprises applying a plurality of bands of the one or more than one additive. In one embodiment, the plurality of bands comprises at least one band with a first density of an additive and another band with a second density of the additive, and the first density is different from the second density. In another embodiment, the plurality of bands comprises at least one band with a first width and another band with a second width, and the first width is different from the second width. In one embodiment, the first width is between 5 mm and 20 mm. In one embodiment, the first width is between 10 mm and 15 mm. In one embodiment, the second width is between 5 mm and 20 mm. In one embodiment, the second width is between 10 mm and 15 mm. In one embodiment, applying the one or more than one additive to a substrate comprises applying a plurality of bands of two or more than two different additives. Further, as will be understood by those with skill in the art with reference to this disclosure, the bands can vary in patterns from each other, that is the bands can comprise edges that are parallel to one another, or can comprise edges that are not parallel to one another.

In a preferred embodiment, applying the one or more than one additive comprises applying the one or more than one additive within the shaping mechanism of a device according to the present invention. In another preferred embodiment, the one or more than one additive is applied to the substrate electrostatically, as will be understood by those with skill in the art with reference to this disclosure, such as for example by using high voltage charges in the range of 2 kV to 10 kV, where droplets of the additive are charged positively or negatively and these charged droplets are attracted to the substrate by the opposite attractive corresponding negative or positive charges which are added to the surface of the substrate or to a surface under the substrate. In a preferred embodiment, the one or more than one additive is applied to the substrate while the substrate is moving. In another preferred embodiment, the one or more than one additive is applied to the substrate by extrusion onto the substrate. In another preferred embodiment, the one or more than one additive is applied to the substrate as a cloud of droplets.

In another preferred embodiment, the one or more than one additive is applied to the substrate in the form of granules or particles to increase the surface area of the additive within the tobacco smoke filter. As will be understood by those with skill in the art with reference to this disclosure, high surface areas are particularly advantageous for substances intended to modify tobacco smoke composition, such as to reduce the amounts or toxicity of potentially harmful components of tobacco smoke.

In a particularly preferred embodiment, the one or more than one additive is applied to the substrate adsorbed onto granules, such as adsorbed onto granules of activated charcoal or of chitin. In a preferred embodiment, the granules have a size in the range of between 30 and 70 mesh. Suitable granules are available from a number of manufacturers. For example, suitable charcoal granules are available from such suppliers as Pica USA, Inc. (Columbus, Ohio US), and Calgon Carbon Corporation (Pittsburgh, Pa. US). Suitable chitin granules are available from such suppliers as WACO Pure Chemical Industries Ltd. (Osaka, Japan), and Funakoshi Co. Ltd. (Tokyo, Japan). In another preferred embodiment, the additive is applied directly to the granules by dipping or spraying, followed by drying.

The one or more than one additive applied by the present method can comprise any of a variety of substances for altering the composition of cigarette smoke or for other purposes, as will be understood by those with skill in the art with reference to this disclosure. In one embodiment, the one or more than one additive is an additive disclosed in the present disclosure. In a preferred embodiment, the one or more than one additive comprises one or more than one substance selected from the group consisting of activated charcoal granules, chitin, chlorophyll, chlorophyllin, CI Reactive Blue 21 dye, copper phthalocyanine, an iron analog CI Reactive Blue 21 dye (where iron replaces the copper ion), a zinc analog CI Reactive Blue 21 dye (where zine the copper ion), ion exchange resin granules and iron phthalocyanine.

In one embodiment, the method for making a tobacco smoke filter comprises: a) providing one or more than one additive and one or more than one substrate; b) applying the one or more than one additive to the one or more than one substrate before the substrate is formed into or spun into fibers; c) forming or spinning the substrate into fibers; d) collecting and crimping the substrate fibers to make tobacco smoke filter two and e) incorporating the tobacco smoke filter tow into the tobacco smoke filter. In a preferred embodiment, the one or more than one substrate is provided by: a) macerating wood pulp; b) reacting the macerated wood pulp with acetic anhydride to acetylate any free hydroxyl groups on the cellulose from the wood pulp; c) dissolving the cellulose acetate in acetone, thereby forming dissolved cellulose acetate; d) applying the one or more than one additive to the dissolved cellulose acetate to form treated cellulose acetate; e) forming the treated cellulose acetate with the one or more than one additive into fibers; f) forming the fibers into cellulose acetate tow; and g) forming the cellulose acetate tow into the tobacco smoke filters. In one embodiment, the one or more than additive is selected from the group consisting of chlorophyllin, chlorophyll, metal phthalocyanines, lignin, cysteine, n-acetylcysteine, rosemary extract, a polycationic polymer, an ion exchange material, and a chitin derivative.

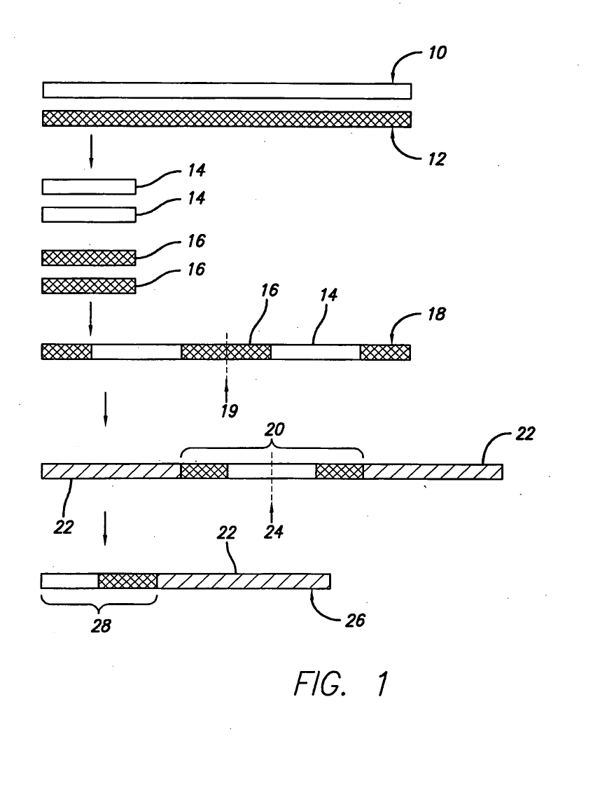

According to another embodiment of the present invention, there is provided a method for making a tobacco smoking product. The method comprises a) providing a tobacco smoke filter according to the present invention; and b) affixing a tobacco segment to the tobacco smoke filter. In one embodiment, the tobacco smoking product comprises an additive according to the present invention. In one embodiment, the tobacco smoking product comprises a composition according to the present invention. In another embodiment, the tobacco smoking product comprises a single segment tobacco smoke filter according to the present invention. In another embodiment, the tobacco smoking product comprises a multiple segment tobacco smoke filter according to the present invention. In another embodiment, the tobacco smoking product comprises a seamed multiple segment tobacco smoke filter according to the present invention. In another embodiment, the tobacco smoking product comprises a seamless multiple segment tobacco smoke filter according to the present invention. As will be understood by those with skill in the art with reference to this disclosure, in one embodiment, the finished tobacco smoking product made according to the present invention comprises a seamless multiple segment tobacco smoke filter and corresponds to the tobacco smoking product 26 shown in FIG. 1, except that there is no seam between the first segment and the second segment of the filter as depicted by the filter 28. Further as will be understood by those with skill in the art with reference to this disclosure, the method for making a multiple segment tobacco smoke filter according to the present invention decreases both the time of production and the cost of producing multiple segment tobacco smoke filters over currently used methods. Further, the present method yields outputs of multiple segment tobacco smoke filters similar to the output of single segment tobacco smoke filters made according to presently used methods.

In one embodiment, the method for making seamless multiple segment tobacco smoke filters according to the present invention uses a continuous flow process on a single machine that does not require mechanically cutting and recombining separate individual filter segments as in the presently used methods, thereby reducing production time and production cost. In another embodiment, the method of the present invention comprises providing a device according to the present invention, such as for example, the device 110. In a preferred embodiment, the device is a modified standard rod maker, such as disclosed in this disclosure, that produces seamless multiple segment tobacco smoke filters at approximately the same rates as currently used methods and devices produce standard tobacco smoke filters.

According to one embodiment of the present invention, after providing the device, the method comprises applying a plurality of spaced bands comprising one or more than one additive that will be present in one or more than one filter segment of the completed tobacco smoke filter onto substrate, such as flattened cellulose acetate tow. In one embodiment, the one or more than one additive comprises a volatile liquid such as ethanol or isopropanol, which evaporates leaving the remainder of the additive behind, or comprises an absorbed liquid such as triacetin (with at least one other substance) which is absorbed into substrate with the remainder of the additive. In another preferred embodiment, the spaced bands are printed on the cellulose acetate tow, rather than sprayed, through contact of the tow with a rotating or otherwise intermittently applied surface coated with an additive in a volatile or absorbed liquid. Suitable printing equipment can be purchased from Aiger Engineering Ltd., Abco Automation Inc., Southlake Corp., and Korber AG among other suppliers.

In one embodiment, the additive is selected from the group consisting of one or more than one substance for selectively reducing the amounts or toxicity of potentially harmful components of tobacco smoke, one or more than one composition for selectively reducing the amounts or toxicity of potentially harmful components of tobacco smoke, and both one or more than one substance for selectively reducing the amounts or toxicity of potentially harmful components of tobacco smoke and one or more than one composition for selectively reducing the amounts or toxicity of potentially harmful components of tobacco smoke. In a preferred embodiment, the composition is a composition for selectively reducing the amounts or toxicity of potentially harmful components of tobacco smoke according to the present invention. In a preferred embodiment, the additive is a composition according to the present invention.

In one embodiment, the method comprises applying a solvent to the substrate and the method further comprises applying the one or more than one additive before the solvent is applied to the substrate. In another embodiment, the method comprises applying a solvent to the substrate and the method further comprises applying the one or more than one additive after the solvent is applied to the substrate. In another embodiment, the method comprises applying a solvent to the substrate and the method further comprises applying the one or more than one additive simultaneously with the application of the solvent to the substrate. In another embodiment, the method comprises applying a solvent to the substrate and the method further comprises applying the one or more than one additive to the substrate at two or more times selected from the group consisting of i) before the solvent is applied to the substrate, ii) after the solvent is applied to the substrate, and iii) simultaneously with the application of solvent to the substrate. In a preferred embodiment, the solvent is triacetin. In another preferred embodiment, the solvent is ethanol. In another preferred embodiment, the solvent is isopropanol. In a preferred embodiment, the substrate is cellulose acetate.

In one embodiment, the method of the present invention further comprises forming a rod from the substrate with the applied bands of the one or more than one additive using standard techniques to form the rod, as will be understood by those with skill in the art with reference to this disclosure, such as for example wrapping a strip of paper around the rod and sealing the strip of paper with hot glue.

In one embodiment, the method of the present invention further comprises cutting the formed rods into finished multiple segment filters. In one embodiment, the finished multiple segment filters are two-segment, multiple segment filters. In another embodiment, the finished multiple segment filters comprise three segments or more than three segments. By way of example only, in one embodiment, cutting the rod comprises cutting the rod in the middle of every second segment comprising the one or more than one additive, thereby producing a multiple segment rod corresponding to the rod 18 as shown in FIG. 1, but where the transition between the segments are seamless. As can be seen, the rod comprises two double length standard segments, one double length non-standard segment between the two standard segments, and two finished length non-standard segments at the ends.

Although the present invention has been discussed in considerable detail with reference to certain preferred embodiments, other embodiments are possible. Therefore, the scope of the appended claims should not be limited to the description of preferred embodiments contained in this disclosure. All references cited herein are incorporated by reference to their entirety.

1-89. (canceled)

90. A composition useful for treating the substrate of a tobacco smoke filter, the composition comprising:
a) one or more than one solvent;
b) one or more than one polycationic polymer; and
c) i) one or more than one free porphyrin, or ii) one or more than one free metal phthalocyanine, or iii) both one or more than one free porphyrin and one or more than one free metal phthalocyanine.

91. The composition of claim 90, where the one or more than one solvent is triacetin.

92. The composition of claim 90, where the composition consists of:
a) triacetin as the solvent;
b) one or more than one polycationic polymer; and
c) one or more than one free copper phthalocyanine.

93. The composition of claim 90, where the composition consists of:
a) triacetin as the solvent;
b) one or more than one polycationic polymer; and
c) one or more than one free iron phthalocyanine.

94. The composition of claim 90, comprising between 40% and 80% triacetin as the solvent, between 10% and 40% polyethyleneimine as the polycationic polymer, and between 10% and 20% free copper phthalocyanine or free iron phthalocyanine.

95. The composition of claim 90, consisting of between 40% and 80% triacetin as the solvent, between 10% and 40% polyethyleneimine as the polycationic polymer, and between 10% and 20% free copper phthalocyanine and free iron phthalocyanine.

96. A tobacco smoke filter comprising an axial length, and further comprising:
a) a substrate; and
b) one or more than one additive;
where the additive comprises one or more than one free porphyrin or one or more than one free metal phthalocyanine, or both one or more than one free porphyrin and one or more than one free metal phthalocyanine.

97. The tobacco smoke filter of claim 96, where the additive further comprises:
a) one or more than one solvent; and
b) one or more than one polycationic polymer.

98. The tobacco smoke filter of claim 96, further comprising a first segment and a second segment, where the additive is not present in the first segment, but where the additive is present in the second segment.

99. A seamless tobacco smoke filter according to claim 98.

100. A tobacco smoke filter comprising an axial length, and further comprising:
a) a substrate; and
b) one or more than one additive;
where the tobacco smoke filter further comprises a first segment and a second segment, where the additive is not present in the first segment, but where the additive is present in the second segment; and
where the tobacco smoke filter is seamless.

101. A tobacco smoke filter comprising a composition according to claim 90.

102. A device for making a tobacco smoke filter from tobacco smoke filter substrate, the device comprising:
a) a rod maker machine comprising a conveyor for moving the substrate through the machine, a shaping mechanism for shaping the substrate into a cylinder, and a cutting mechanism for cutting the shaped substrate into segments;
b) an applicator for applying one or more than one additive intermittently to the substrate in a plurality of spaced bands; and
c) a controller for controlling the applicator, where the controller is connected to the applicator.

103. The device of claim 102, where the rod maker machine further comprises a mechanism for applying triacetin to the substrate; and
where the applicator applies the additive to the substrate after the mechanism for applying triacetin applies triacetin to the substrate.

104. The device of claim 102, where the applicator comprises one or more than one spray head for spraying the additive intermittently to the substrate in a plurality of spaced bands.

105. The device of claim 102, where the applicator comprises one or more than one rotatable wheel template for applying an additive intermittently to the substrate in a plurality of spaced bands.

106. The device of claim 102, where the applicator comprises one or more than one pump for pumping the additive through the applicator.

107. The device of claim 102, further comprising a sensor and a cable attached to the sensor and to the applicator to convey synchronizing signals to the applicator, thereby triggering the application of the spaced bands.

108. The device of claim 102, where the applicator is positioned to apply the one or more than one additive to the substrate before the substrate enters the shaping mechanism.

109. The device of claim 102, where the applicator is positioned to apply the one or more than one additive to the substrate while the substrate is within the shaping mechanism.

110. The device of claim 102, where the applicator is positioned to apply the one or more than one additive to the substrate after the substrate has been shaped by the shaping mechanism.

111. A method for making a tobacco smoke filter, the method comprising:
a) providing a composition according to claim 90;
b) applying the composition to a substrate; and
c) incorporating the substrate into a tobacco smoke filter.

112. The method of claim 110, where the tobacco smoke filter made is a seamless multiple segment tobacco smoke filter.

113. The method of claim 111, where applying the composition comprises applying a plurality of spaced bands of the composition.

114. The method of claim 111, further comprising applying a solvent to the substrate; and further comprising applying the composition after the solvent is applied to the substrate.

115. A method for making a tobacco smoke filter according to claim 96, the method comprising:
a) providing the substrate;
b) providing the one or more than one additive; and
c) applying the one or more than one additive to the substrate.

116. A method for making a tobacco smoke filter according to claim 100, the method comprising:
a) providing the substrate;
b) providing the one or more than one additive; and
c) applying the one or more than one additive to the substrate.

117. A method for making a tobacco smoke filter, the method comprising:
a) providing a device according to claim 102;
b) allowing the applicator of the device to apply the one or more than one additive to a substrate; and
c) incorporating the substrate into the tobacco smoke filter.

118. A method for making a tobacco smoke filter, the method comprising:
a) providing one or more than one additive and one or more than one substrate;
b) applying the one or more than one additive to the one or more than one substrate before the substrate is formed into or spun into fibers;
c) forming or spinning the substrate into fibers;
d) collecting and crimping the substrate fibers to make filter tow; and
e) incorporating the filter tow into the tobacco smoke filter.

119. The method of claim 118, where the one or more than one substrate is provided by:
a) macerating wood pulp;
b) reacting the macerated wood pulp with acetic anhydride to acetylate any free hydroxyl groups on the cellulose from the wood pulp;
c) dissolving the cellulose acetate in acetone, thereby forming dissolved cellulose acetate;
d) applying the one or more than one additive to the dissolved cellulose acetate to form treated cellulose acetate;
e) forming the treated cellulose acetate with the one or more than one additive into fibers;
f) forming the fibers into cellulose acetate tow; and
g) forming the cellulose acetate tow into the tobacco smoke filters.

120. The method of claim 118, where the one or more than additive is selected from the group consisting of chlorophyllin, chlorophyll, metal phthalocyanines, lignin, cysteine, n-acetylcysteine, rosemary extract, a polycationic polymer, an ion exchange material, and a chitin derivative.
